(19) United States
(12) Patent Application Publication
(10) Pub. No.: US 2006/0156842 A1
(43) Pub. Date: Jul. 20, 2006

(54) Bevel gear, in particular a hypoid bevel gear

(76) Inventors: Karl-Georg Melber, Weikersheim-Elpersheim (DE); Michael Engelbreit, Riedenbhim (DE)

Correspondence Address: BACHMAN & LAPOINTE, P.C., 900 CHAPEL STREET, SUITE 1201, NEW HAVEN, CT, 06510, US

(21) Appl. No.: 10/522,702

(22) PCT Filed: May 15, 2003
(86) PCT No.: PCT/EP03/05098

§ 371 Date: Jan. 28, 2005

(30) Foreign Application Priority Data
Jul. 30, 2002 (DE) 102 34 749.2

(51) Int. Cl. F16H 1/14

(52) U.S. Cl. 74/423

(57) ABSTRACT

A bevel gear, in particular a hypoid bevel gear comprising an output shaft that is mounted in a housing. A bevel wheel, which co-operates with a drive pinion, is allocated to the shaft. A single-stage or multi-stage gear is mounted upstream of the hypoid stage, or a drive shaft can be inserted in a modular manner upstream of the stage.

### BACKGROUND OF THE INVENTION

The invention relates to a bevel gear mechanism, in particular hypoid bevel gear mechanism with an output shaft which is mounted in a housing and which is assigned a bevel gear which interacts with a drive bevel gear.

Such bevel gear mechanisms, in particular hypoid bevel gear mechanisms, are commercially available and known and customary in a variety of forms and embodiments. They are used, in particular, for deflecting torque by, for example, 90°, and the intention is that other ranges of deflection will also lie within the scope of the present invention.

A disadvantage with conventional gear mechanisms is that they have to be redesigned and reconfigured for different customer-specific requirements in each case. In particular, customer-specific requirements are, for example, different drive sleeves, drive shafts, different transmission ratios, different receptacle for output elements or the like.

Owing to the customer-specific variety, conventional hypoid bevel gear mechanisms are manufactured in a very wide variety of variants. This is very expensive and costly in terms of fabrication technology.

DE 199 57 743 A discloses an angular gear mechanism in which a bevel gear is seated a drive shaft, said bevel gear driving a hollow shaft which is arranged perpendicularly thereto.

DE 24 03 504 A discloses a bevel gear mechanism in which two shafts are arranged perpendicularly with respect to one another in a common plane and the shafts each have bevel gears which engage one in the other.

U.S. Pat. No. 5,816,116 describes a hypoid bevel gear mechanism from which special flange arrangements for suspending the angular gear mechanism are provided.

The publication from the periodical Machine Design of 23.07.1993, Vol. 65, No. 15, page 38, ISSN: 00249114 discloses an angular gear mechanism, a shaft which is supported in a flange and on which a bevel gear is seated being provided within the angular gear mechanism. Said bevel gear intermeshes with a bevel gear of an output shaft.

The present invention is based on the object of providing a bevel gear mechanism, in particular a hypoid bevel gear mechanism, which eliminates the aforesaid disadvantages and with which it is possible to use standard components which can be used very cost-effectively and easily to construct a bevel gear mechanism to which, for example, any desired output elements or drive elements can be connected in a modular fashion on a customer-specific basis. The intention of this is to reduce fabrication costs while at the same time increasing the flexibility of the bevel gear mechanism.

### SUMMARY OF THE INVENTION

The foregoing object is obtained by providing a bevel gear mechanism as described hereinbelow.

In the present invention it is particularly advantageous to connect a single stage or multistage gear mechanism or a drive shaft which is dimensioned in any desired way to the hypoid stage in a modular fashion by means of a flange. Corresponding customer-specific dimensioning of the drive shaft, for example in terms of diameter, length etc., preferably accommodated in an assembly, can thus be taken into account without the hypoid stage having to be changed. All that is necessary to do this is for the assembly which contains the drive shaft to be customized so that the rest of the bevel gear mechanism can be inserted and used for different drive shafts or assemblies.

In this context, the assembly containing the drive shaft can be replaced very quickly and easily with the bevel gear mechanism or by a single stage or multistage gear mechanism.

This also has the advantage that, for example, in the case of a repair, all that is necessary, for example, is to disconnect the flanges of the single stage or multistage gear mechanism from the bevel gear mechanism or the hypoid stage, or to replace it, if, for example, said single stage or multistage gear mechanism is damaged. In addition, a bevel gear mechanism which has any desired possibilities at the drive end and at the output end can be implemented in a customer-specific fashion.

In addition, it has proven advantageous that, in particular, the assembly and the rest of the bevel gear mechanism are divided into different lubrication spaces so that, on the one hand, it is possible to operate with different lubrication means and, on the other hand, the assemblies can be interchanged between the different bevel gear mechanisms, for example a single stage or multistage gear mechanism and a drive shaft, easily and quickly at any time without having to take into account the lubrication means and their filling levels.

In addition, it has proven advantageous with the present invention to construct the output shaft at at least one end region as an output flange in order to receive different output elements. In addition, it is advantageous in the present invention that, for example, a shoulder for receiving the main bearing is formed directly from part of the output shaft.

However, it is at the same time also possible to construct a shoulder from the bevel gear in order to receive the main bearing of the output shaft.

A further advantage in the present invention is that the bevel gear and output shaft are embodied in two parts, in particular so as to be capable of being connected to one another in a releasable fashion so that mounting, and if appropriate also repair, are made significantly easier. In addition it is also ensured that an extremely short overall length is implemented by means of this design. The two-part design of the bevel gear and output shaft and the supporting of the main bearing on the shoulder of the output shaft allow main bearings which have dimensions of the same magnitude to be used and introduced so that overall the stability and the service life are optimized while the variety of parts is reduced. This is also to lie within the scope of the present invention.

In addition, with the present invention it is possible to implement a bevel gear mechanism for which transmission ratios of, for example, 1 to 10 can be selected with a reduced overall length, while this can also be brought about by arranging a single stage or multistage gear mechanism in front of the hypoid stage or the bevel gear mechanism. Said single stage or multistage gear mechanism is likewise very easily exchangeable. Various bevel customer-specific gear mechanisms which can be manufactured in accordance with the customer's wishes with few changes and modifications can thereby be realized.

### BRIEF DESCRIPTION OF THE DRAWINGS

Further advantages, features and details of the invention emerge from the following description of preferred exemplary embodiments and with reference to the drawing, in which:

FIG. 1 shows a schematically illustrated longitudinal section through a bevel gear mechanism, in particular hypoid bevel gear mechanism with an attached single stage or multistage gear mechanism;

FIG. 2 shows a partial longitudinal section through a bevel gear mechanism as a further exemplary embodiment; and

FIG. 3 shows a schematically illustrated longitudinal section through a further exemplary embodiment of a further bevel gear mechanism according to FIGS. 1 and 2.

### DETAILED DESCRIPTION

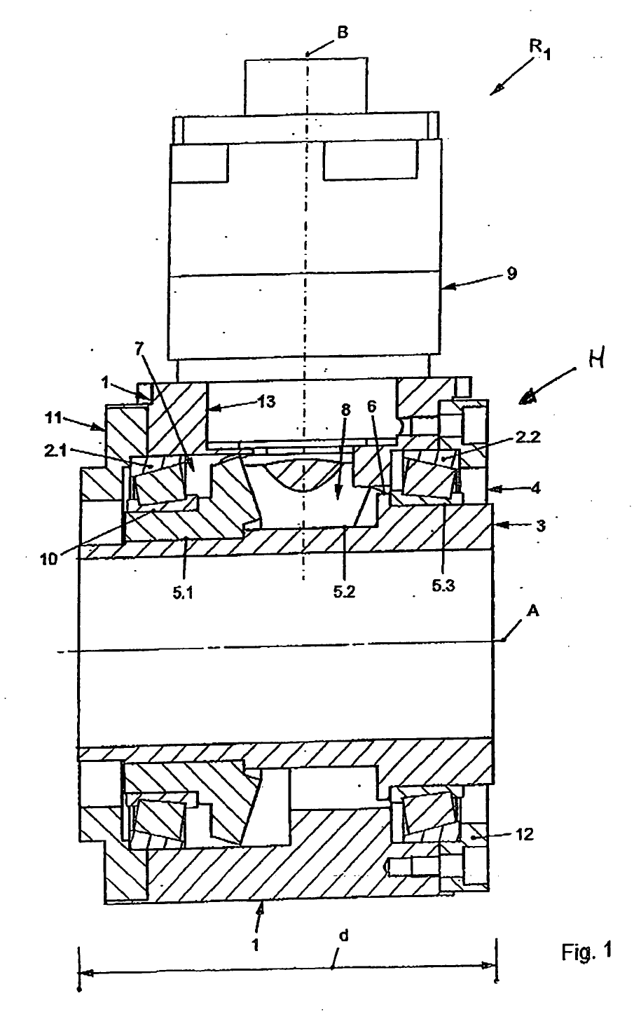

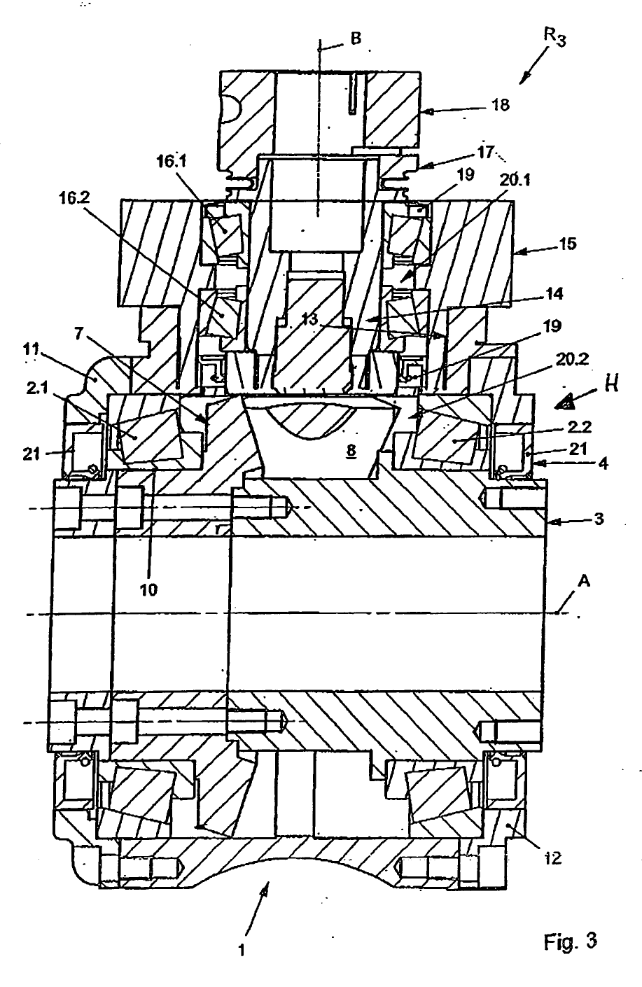

According to FIGS. 1 and 3, a bevel gear mechanism R₁ according to the invention has a housing 1 in which two main bearings 2.1, 2.2 are respectively mounted spaced apart from one another in end regions and a through opening 4, in which the output shaft 3 is inserted, is provided within the housing 1.

The output shaft 3 is provided with a plurality of different shaft shoulders 5.1 to 5.3. A stop 6 for providing support to the main bearing 2.2 on one side is provided between the shaft shoulders 5.2 and 5.3. The main bearing 2.2 is seated on the shaft shoulder 5.3 of the output shaft 3.

A bevel gear 7 is seated in a rotationally fixed fashion on the shaft shoulder 5.1 on the output shaft 3. The bevel gear 7 can be connected in a rotationally fixed fashion to the output shaft 3 by means of corresponding shaft hub connections, wedge shaft connections or by shrink fits, and can be driven by means of a corresponding drive bevel gear 8, which is only indicated here, and causes the output shaft 3 to rotate about the axis A.

In the present exemplary embodiment, the drive bevel gear 8 is seated on a single stage or multistage gear mechanism 9 and is mounted so as to be capable of rotating about the axis B by means of the gear mechanism 9.

In order to obtain the smallest possible overall length L, it is advantageous in the present invention that a shoulder 10 is formed from the bevel gear 7 and the main bearing 2.1 is seated on said shoulder 10 or the main bearing 2.1 is inserted between the shoulder 10 and housing 1, ensuring radial and/or axial support of the output shaft 3. A closure lid 11 at one end of the through opening 4 or at one end of the output shaft 3 serves to secure the main bearing 2.1 axially.

At the other end in the region of the main bearing 2.2, a bearing lid 12 which also axially secures the main bearing 2.2 in the region of the housing 1 is provided, the main bearing 2.2 being secured on the shaft shoulder 5.3 with respect to the stop 6.

In this way, very simple mounting with an extremely short overall length L is obtained so that by means of the main bearings 2.1, 2.2 the output shaft 3 is clamped in axially inside the housing 1 and is mounted in a radially rotatable fashion. Combining the main bearing 2.1 on the bevel gear 7 forms a bevel gear mechanism which withstands high stresses and at the same time permits main bearings 2.1 and 2.2 which are dimensioned so as to be strong and have a reduced overall length L.

In addition, mounting, in particular disassembly, for example in the case of a repair, is made easier in that only the closure lid 11 and bearing lid 12 have to be removed from the end of the housing 1 in order to subsequently remove or pull out the main bearings 2.1 and 2.2, respectively, so that the output shaft 3 can then be removed from the through opening 4 with or without the bevel gear 7, depending on the connection.

It is also conceivable, if only the bevel gear 7 is to be replaced, for the bevel gear 7 to be simply pulled off the shaft shoulder 5.1 by opening the closure lid 11 and pulling off the main bearing 2.1.

In addition, it has proven advantageous in the present exemplary embodiment that a single stage or multistage gear mechanism 9 can be quickly and releasably connected to the hypoid stage H of the bevel gear mechanism R₁ with a flange 13 with, if appropriate, a drive bevel gear 8, in which case it is also possible to consider inserting any desired drive shaft 14 with, if appropriate, drive bevel gear 8, see FIG. 3, into the same flange 13 instead of the gear mechanism 9.

In this context, the same flange 13 can be used universally to accommodate the gear mechanism 9 or any desired drive shaft 14 so that in this way a modular design is provided. It is possible to use user-specific drive shafts 14 with different dimensions or gear mechanisms 9 with, if appropriate, different transmission ratios. This is also intended to lie within the scope of the present invention.

In addition, it is important with the present invention that, as is indicated in particular in the exemplary embodiment of the present invention according to FIG. 3, the drive shaft 14 of a bevel gear mechanism R₃ can, for example, be inserted as an assembly 15 into the flange 13, the assembly 15 having bearing elements 16.1, 16.2 which support the drive shaft 14 to which a coupling 17 (not indicated here) with a connecting sleeve 18 for any desired drive element is connected.

Outside the bearing elements 16.1, 16.2, sealing elements 19 are provided which seal off the assembly 15 from the drive bevel gear 8 and from the coupling 17 in the outward direction, a first lubrication space 20.1 being formed. This lubrication space 20.1 is independent of a second lubrication space 20.2 which is delimited by means of further sealing elements 21 between the housing 1 and output shaft 3 or bevel gear 7, in particular between the closure lid 11 and the bevel gear 7 and output shaft 3 and bearing lid 12.

In this way, separate lubrication spaces 20.1 and 20.2 are formed so that different lubrication means can be used in the active region of the bevel gear 7 and drive bevel gear 8 and in the region of the drive shaft 14.

In addition, this arrangement also always ensures permanent lubrication of the drive shaft 14 too in a way which is independent of position. In addition, the separate lubrication spaces ensure that the drive shaft 3 and bevel gear 7 or drive bevel gear 8 can be operated with different lubrication means, lubrication greases or different lubrication oils.

In this way, it is also possible to use different user-specific or load-specific lubricants in the lubrication spaces 20.1, 20.2.

In addition, it is advantageous that the assembly 15 of the bevel gear mechanisms R₁ to R₃ can readily be replaced very easily and quickly.

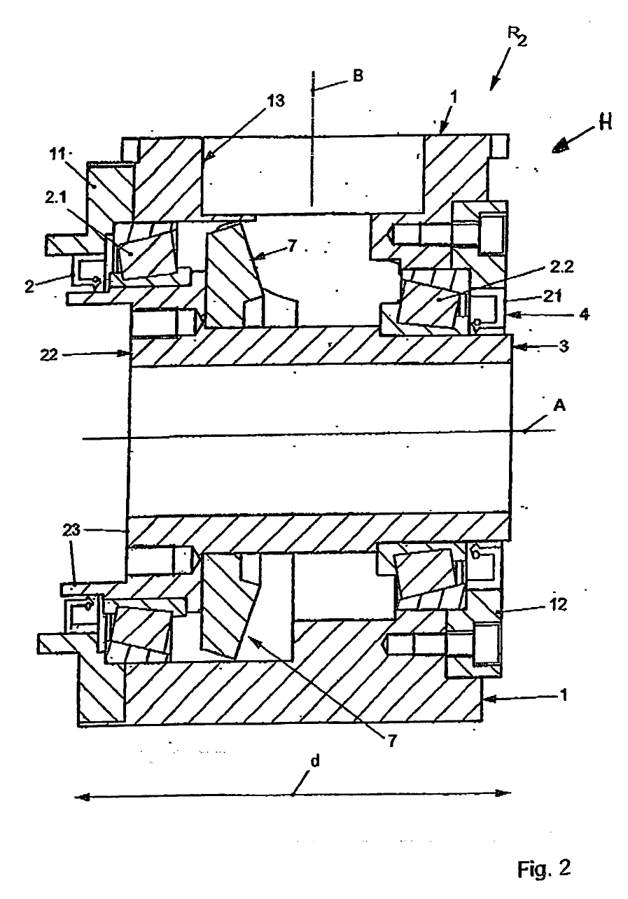

In the exemplary embodiment of the present invention according to FIG. 2, a bevel gear mechanism R₂ is shown which corresponds approximately to that according to FIG. 1. The difference is that the output shaft 3 has an end shoulder on which the main bearing 2.1 is seated. In an end region 22, the output shaft 3 is embodied as an output flange 23 for mounting any desired drive elements (not illustrated here). The drive shaft 3.1 is also divided here into stages, in order, on the one hand, to push on the main bearing 2.2 and to connect the bevel gear 7 in a central region to the output shaft 3 in a positively or frictionally locking fashion.

A further particular feature of the present invention is also that the end region 22 of the output flange 23 is let in within the closure lid 11 so that in total an overall length L of the bevel gear mechanism R₂ is reduced. In addition, any desired drive elements can be connected by flanges in an easy and a straightforward fashion.

FIG. 3 shows a bevel gear mechanism R₃ in which the bevel gear 7 and output shaft 3 are connected to one another in two parts, in particular bolted to one another. In order to ensure radial centering, a shoulder 24 is formed between the bevel gear 7 and output shaft 3 and they engage one in the other. The two-part embodiment simplifies mounting, disassembly and fabrication.

1-12. (canceled)

13. A bevel gear mechanism, in particular hypoid bevel gear mechanism, comprising an output shaft (3) which is mounted in a housing (1) and which is assigned a bevel gear (7) which interacts with a drive bevel gear (8), wherein a single stage or multistage gear mechanism (9) which is dimensioned differently is arranged in front of a hypoid stage (H) so as to be capable of being plugged in a modular fashion, the drive bevel gear (8) being seated on the single stage or multistage gear mechanism (9) and intermeshing with the bevel gear (7) of the output shaft (3).

14. A bevel gear mechanism, in particular hypoid bevel gear mechanism, comprising an output shaft (3) which is mounted in a housing (1) and which is assigned a bevel gear (7) which interacts with a drive bevel gear (8), wherein the output shaft (3) has an output flange (23) for adapting output elements.

15. A bevel gear mechanism, in particular hypoid bevel gear mechanism, comprising an output shaft (3) which is mounted in a housing (1) and which is assigned a bevel gear (7) which interacts with a drive bevel gear (8), wherein one region of the drive unit and one region of the hypoid gear mechanism connected thereto are divided into lubrication spaces (20.1, 20.2) which are independent of one another.

16. The bevel gear mechanism as claimed in at least one of claims 13 to 15, wherein the output shaft (3) and bevel gear (7) are arranged in two parts so as to be capable of being connected to one another on an axis (A, B).

17. The bevel gear mechanism as claimed in claim 13, wherein the single stage or multistage gear mechanism (9) or the drive shaft (14) can be plugged in a modular fashion in one and the same central flange (13) of the housing (1) in order to mesh with the bevel gear (7) of the output shaft (3).

18. The bevel gear mechanism as claimed in at least one of claims 14 and 15, wherein the bevel gear (7) is provided with a shoulder (10) on which a main bearing (2.1) of the output shaft (3) is seated and supported with respect to the housing (1) and, if appropriate, a closure lid (11).

19. The bevel gear mechanism as claimed in at least one of claims 14 and 15, wherein the bevel gear (7) is connected at the end to the output shaft (3), in particular bolted thereto, wherein at least one shoulder (24) is provided in the bevel gear (7) and output shaft (3) for the purposes of radial centering.

20. The bevel gear mechanism as claimed in claim 19, wherein the main bearing (2.1) is supported on the shoulder (10) of the bevel gear (7).

21. The bevel gear mechanism as claimed in at least one of claims 14 and 15, wherein the bevel gear (7) is plugged in a rotationally fixed fashion onto the output shaft (3), and the main bearing (2.1) is provided between a shoulder (10) of the bevel gear (7) and the housing (1).

22. The bevel gear mechanism as claimed in claim 15, wherein the output shaft (3) is constructed at one end as an output flange (23) for adapting any desired output elements, wherein a main bearing (2.1) is provided between a shoulder (10) of the output flange (23) and the housing (1) for the purpose of radially supporting the output shaft (3).

23. The bevel gear mechanism as claimed in claim 16, wherein one (20.2) of the lubrication spaces is formed between the sealing elements (19) located outside the main bearings (2.1, 2.2), and between the output shaft (3) and bevel gear (7) and housing (1).

24. The bevel gear mechanism as claimed in claim 23, wherein the other lubrication space (20.1) is formed between the sealing elements (19) of the drive shaft (3) and the drive flange (23).
